(19) United States
(12) Patent Application Publication
(10) Pub. No.: US 2015/0282030 A1
(43) Pub. Date: Oct. 1, 2015

(54) METHOD AND APPARATUS FOR REDUCING POWER CONSUMPTION IN VOLTE ENABLED DEVICES

(71) Applicant: Samsung Electronics Co., Ltd., Gyeonggi-do (KR)

(72) Inventors: Tushar VRIND, Gyeonggi-do (KR); Prasad Basavaraj Dandra, Bangalore (IN); Shrinath Ramamoorthy Madhurantakam, Bangalore (IN)

(73) Assignee: Samsung Electronics Co., Ltd.

(21) Appl. No.: 14/663,849

(22) Filed: Mar. 20, 2015

Related U.S. Application Data
(60) Provisional application No. 61/973,523, filed on Apr. 1, 2014.

(30) Foreign Application Priority Data
Feb. 11, 2015 (KR) 10-2015-0020939

(51) Int. Cl. H04W 36/16; H04W 72/04; H04W 76/04

(52) U.S. Cl. CPC H04W 36/16; H04W 76/048; H04W 72/0453

(57) ABSTRACT

An apparatus and method are provided for reducing power consumption in a user equipment (UE). The method includes establishing, by the UE, a connection with a network; receiving, by the UE, from the network, system information of at least one of a resident cell and a neighboring cell indicating if a network feature is supported by the at least one of the resident cell and the neighboring cell; determining, by the UE, if a selection criteria of a cell from among the at least one of the resident cell and the neighboring cell, which supports the network feature, is greater than a threshold; reselecting the cell having the selection criteria that is greater than the threshold; and initiating a connection establishment with the reselected cell, which supports the network feature.

### PRIORITY

This application claims priority under 35 U.S.C. §119 to U.S. Provisional Application Ser. No. 61/973,523, which was filed in the U.S. Patent and Trademark Office on Apr. 1, 2014, and to Korean Patent Application No. 10-2015-0020939, which was filed in Korean Intellectual Property Office on Feb. 11, 2015, the entire content of each of which is incorporated herein by reference.

### FIELD OF TECHNOLOGY

The present disclosure relates generally to wireless communication, and more particularly, to an apparatus and method for power efficient system selection for a voice over interne protocol (VoIP) over long term evolution (LTE) (VoLTE) enabled device.

### BACKGROUND

VoLTE based calling is an emerging method for establishing a call from one User Equipment (UE) to the other UEs. Accordingly, different policies, such as, connected mode discontinuous reception (CDRX), semi-persistent scheduling (SPS), dynamic scheduling (DS), etc., are being proposed to improve effectiveness and reduce power consumption in VoLTE based calling.

CDRX has been introduced to reduce UE power consumption during a call. Specifically, CDRX allows the UE to remain in connection with a base station or an evolved Node B (eNB) while periodically powering down or entering into a sleep mode based on data traffic conditions in order to reduce power consumption. For example, the base station can pre-configure the UE's sleep periods in anticipation of predictable arrival of frames related to a data call.

With DS, a UE can get scheduling assignments/grants in every subframe, which provides a network with full flexibility in assigning resources to the UE at the cost having to transmit resource allocation information on a physical downlink control channel (PDCCH) in every subframe. Additionally, DS provides the flexibility of varying the resource allocation based on reported channel conditions and the resources can be allocated periodically.

However, as a packet size is small and an inter-arrival time of VoIP packets is constant for services such as VoIP, the control signaling overhead (e.g., the PDCCH) is too large for an Evolved Universal Mobile Telecommunications System Terrestrial Radio Access Network (E-UTRAN) to support a large number of VoIP users.

SPS has been introduced to reduce traffic over control signaling due to a transmission time interval (TTI) based grant allocation, and reducing UE power consumption. An eNB configures a UE with SPS only once in order to receive uplink/downlink (UL/DL) resources at a specific interval. Further, SPS reduces power consumption of the UE, as the UE is not required to decode all PDCCH packets.

Currently, if a UE is in coverage region of more than one eNB or cell, and when UE is camped and in an idle mode, the UE will be unaware whether the serving cell supports SPS and/or CDRX. Further, even after moving to a connected mode, e.g., for a VOLTE call, if a serving cell's signal condition is good and the serving cell does not support either of SPS or CDRX, the UE still remains camped on the particular cell. Thus, the UE is unable to conserve power because of lack of information on whether a serving cell supports SPS or CDRX.

Thus, a need exists for an effective method for power efficient system selection for a VoLTE enabled device.

### SUMMARY

Accordingly, the present disclosure is provided to address at least the problems and/or disadvantages described above and to provide at least the advantages described below.

Accordingly, an aspect of the present invention is to provide an improved apparatus and method for reducing power consumption in a wireless UE.

In accordance with an aspect of the present disclosure, a method is provided for reducing power consumption in a UE. The method includes establishing, by the UE, a connection with a network; receiving, by the UE, from the network, system information of at least one of a resident cell and a neighboring cell indicating if a network feature is supported by the at least one of the resident cell and the neighboring cell; determining, by the UE, if a selection criteria of a cell from among the at least one of the resident cell and the neighboring cell, which supports the network feature, is greater than a threshold; reselecting the cell having the selection criteria that is greater than the threshold; and initiating a connection establishment with the reselected cell, which supports the network feature.

In accordance with an aspect of the present disclosure, a method is provided for a UE to reduce power consumption in the UE. The method includes storing, by the UE, information of neighboring cells supporting a network feature and a plurality of parameters based on prior camping history and connection establishment of the UE; initiating a call initiating a call through a network; evaluating, by the UE, the plurality of parameters to determine if a selection criteria of a cell supporting the network feature is greater than a threshold; reselecting the cell having the selection criteria that is greater than the threshold; and initiating a connection establishment with the reselected cell, which supports the network feature.

In accordance with an aspect of the present disclosure, an apparatus is provided for reducing power consumption in a UE. The apparatus includes a transceiver configured to establish a connection with a network, to receive, from the network, system information of at least one of a resident cell and a neighboring cell indicating if a network feature is supported by the at least one of the resident cell and the neighboring cell; and a controller configured to determine if a selection criteria of a cell from among the at least one of the resident cell and the neighboring cell, which supports the network feature, is greater than a threshold, to reselect the cell having the selection criteria that is greater than the threshold, and to initiate a connection establishment with the reselected cell, which supports the network feature.

### BRIEF DESCRIPTION OF THE DRAWINGS

The above and other aspects, features, and advantages of certain embodiments of the present disclosure will be more apparent from the following detailed description taken in conjunction with the accompanying drawings, in which:

FIG. 1 illustrates a method of selecting cells that support SPS/CDRX, according to an embodiment of the present disclosure;

FIG. 2 illustrates a method of selecting cells that support SPS/CDRX, according to an embodiment of the present disclosure;

FIG. 3 illustrates a method of selecting cells that support SPS/CDRX, according to an embodiment of the present disclosure; and

FIG. 4 is a block diagram illustrating a UE according to an embodiment of the present disclosure.

### DETAILED DESCRIPTION OF THE EMBODIMENTS

Various embodiments of the present disclosure provide a method and system for providing power efficient system selection for a VoLTE enabled device. In the following detailed description, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present disclosure. The following detailed description is, therefore, not to be taken in a limiting sense, and the scope of the present disclosure is defined only by the appended claims and any equivalents thereof.

Further, although specific features of the present disclosure are illustrated in some drawings and not in others. This is done for convenience only as each feature may be combined with any or all of the other features in accordance with the present disclosure.

The specification may refer to “an”, “one” or “some” embodiment(s) in several locations, which does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Various embodiments are described below, which are related to reducing power consumption in a UE during a data call. Specifically, effective methods are provided for a cell selection that supports SPS/CDRX for a VoLTE enabled device, in order to reduce power during a data call.

The various embodiments herein provide methods for selecting cells that support SPS/CDRX and camping over to the selected cells to reduce power during a data call, wherein the cell selected for camping to reduce power consumption of the UE can be selected out of plurality of cells, which are either neighbors to each other or overlapping with each other.

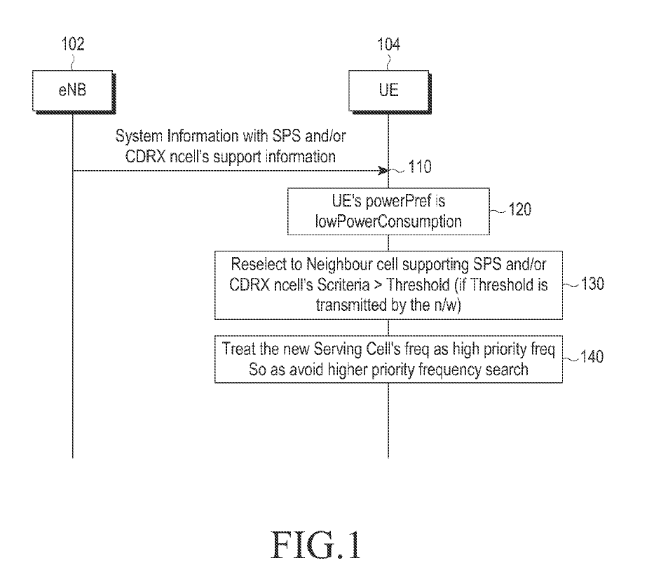

FIG. 1 illustrates a method of selecting cells that support SPS/CDRX, according to an embodiment of the present disclosure.

Referring to FIG. 1, reselection from a cell 1 to a cell 2 that supports SPS/CDRX is performed after a UE 104 receives feature support information from the cell 1. Specifically, the UE 104 camps on an eNB 102 in a wireless network, which acts as a resident cell for the UE 104.

Once camped, the eNB 102 in the network sends system information or downlink information of the resident cell supporting a network feature to the UE 104 in step 110. For example, the network features may include SPS and/or CDRX.

Alternatively, in step 110, the eNB 102 may send system information or downlink information of a list of neighboring cells along with the resident cell indicating support of a network feature to the UE 104. For example, the network feature may include SPS and/or CDRX of neighbor cells/frequencies.

In accordance with another embodiment of the present disclosure, the UE 104 may maintain a list of neighboring cells, which includes the information relating to the cells supporting the network features and a plurality of parameters based on a prior camping history and connection establishment.

The UE 104 maintains set of criteria for selecting a cell for accessing services from the cell. For example, the set of criteria may include power status, network features being supported, etc. The UE 104 may also set a threshold prior to selecting the cell for accessing network features.

In step 120, the UE 104 checks the power status and identifies whether power consumption preference is set as low power consumption.

In step 130, if the power preference Indicator of the UE 104 is set as low power consumption, and if selection criteria (S-criteria) of the target cell is greater than a threshold, then based on network feature support indication, UE 104 reselects to the cell supporting the SPS/CDRX policies.

In step 140, the UE 104 treats the frequency of the new service cell as a high priority frequency.

Thereafter, upon initiation of a call, the UE 104 initiates connection establishment with the reselected cell, which supports the network features.

The reselection of a cell can also be done between two or more cells by identifying a better cell among the cells. For example, when two cells, cell-A and cell-B, are provided to the UE for reselection, and the cell-A supports SPS/CDRX but the cell-B does not support the SPS/CDRX, the UE can apply an offset (bias) to select the cell for camping based on the following.

Specifically, the UE can reselect Cell-A if, S_{nonServingCell,x} of a cell-A on evaluated frequency is greater than Thresh_{x, high}−Offset_{PowerSave} during a time interval T_{reselection}, wherein OffSet_{PowerSave} can be broadcasted by the network or implementation specific offset, and UE can reselect Cell-B if, S_{nonServingCell,x} of a cell-B on evaluated frequency is greater than Thresh_{x, high} during a time interval T_{reselection}.

Herein, the S_{nonServingCell,x} is S-criteria of the non-serving cell, as discussed in 3GPP Specification 36.304.

Thresh_{x, high} specifies the threshold used by the UE when reselecting towards the higher priority frequency X than current serving frequency. Each frequency of E-UTRAN and UTRAN, each group of GERAN frequencies, each band class of CDMA2000 HRPD and CDMA2000 1xRTT might have a specific threshold.

T_{reselection} is the time interval for which the target should satisfy the reselection criteria for reselection to initiate from source to target cell, as discussed in the 3GPP Specification 36.304.

Offset_{powersave} specifies the offset between the two cells, if the target cell supports features, namely, SPS and/or CDRX, which can be network specified or UE implementation.

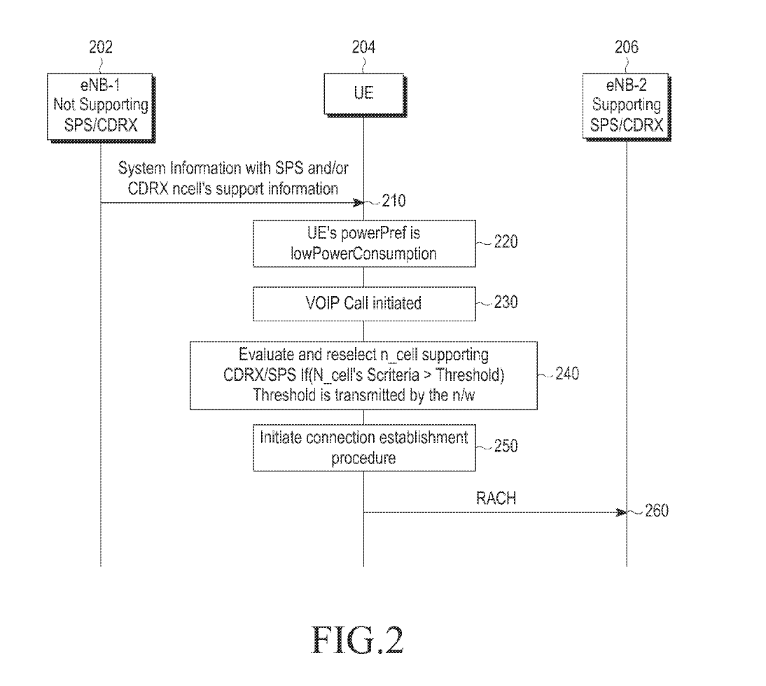

FIG. 2 illustrates a method of selecting cells that support SPS/CDRX, according to an embodiment of the present disclosure.

Referring to FIG. 2, reselection of a cell by a UE 204 can be done during a call initiation process, i.e., the UE 204 will remain camped on a cell 1 that does not support certain features, e.g., SPS and CDRX, until a call is initiated. Once a call is initiated, the UE 204 will reselect a cell 2, which supports the certain features, and establish a connection on cell 2.

More specifically, while the UE 204 is camped on eNB-1 202, which does not support a network feature, in step 210, the eNB-1 202 sends its own system information or downlink information, which indicates whether it supports a network feature, to the UE 204.] For example, the network features may include SPS and CDRX. Alternatively, in step 210, the eNB-1 202 may send system information of a list of neighboring cells with cellist own information indicating support for a network feature to the UE 204. For example, the network features may include SPS and CDRX of neighbor cells/frequencies.

In accordance with another embodiment of the present disclosure, the UE 204 may maintain a list of neighboring cells, which includes information relating to the cells' support of the network features and a plurality of parameters based on a prior camping history and connection establishment.

The UE 204 identifies and considers plurality of parameters before reselecting a cell for camping and accessing services to ensure that the reselected cell can provide better service than the resident cell, i.e., current cell. For example, the plurality of parameters include a high priority frequency associated with a cell, an equal priority frequency associated with a cell, and a lower priority frequency associated with a cell.

The UE 204 can also set a predefined threshold for the plurality of parameters to reselect the cell. Specifically, in step 220, the UE 204 sets the predefined threshold to low power consumption.

Upon call initiation by the UE 204 in step 230, the UE 204 evaluates a plurality of parameters to determine if a selection criteria of a cell supporting the network feature(s) is greater than a pre-set threshold in step 240. In accordance with an embodiment of the present disclosure, the UE 204 evaluates cells for re-selection to a neighboring cell of a high priority frequency, for example, based on at least one of a network feature support indication provided by the network and a network feature support of cells maintained by the UE 204. In accordance with another embodiment of the present disclosure, the UE 204 evaluates cells for re-selection to a neighboring cell having an equal priority frequency, for example, based on at least one of a network feature support indication from the network, and a network feature support of cells maintained by the UE 204. In accordance with another embodiment of the present disclosure, the UE 204 evaluates cells for re-selection to a neighboring cell having a lower priority frequency, for example, based on at least one of a network feature support indication from the network, and a network feature support of cells maintained by the UE 204.

The UE 204 may apply an offset to the selection criteria of the neighboring cell supporting the network features, when the UE 204 reselects the neighboring cell of a high priority frequency, an equal priority frequency, or a lower priority frequency, wherein the offset can be network configured or UE implemented.

In step 250, the UE 204 initiates a connection establishment with a reselected cell eNB-2 206, which supports the network features, by transmitting a random access channel in step 260.

As described above, upon initiating the call, the UE 204 can evaluate and reselect to the cell supporting the SPS/CDRX, if a selection criteria (S-criteria) of a target cell is better than a threshold. For example, the broadcast system information includes network related information about neighboring cells, and the threshold value can be provided by a network. After reselecting, the UE 204 can initiate the connection establishment on the reselected neighbor cell eNB-2 206 with good S-criteria and supporting SPS/CDRX policy. The UE 202 treats the frequency of the eNB-2 206 cell as a high priority frequency.

As described above, a UE can perform reselection of a cell between two or more cells. The UE performs evaluation of the two or more cells for ranking equal priority neighbor cells for a reselection operation, before camping on any of them to access SPS/CDRX. For example, when two cells, cell-A and cell-B of higher priority frequency, are provided to the UE for evaluation and ranking, and the cell-A supports SPS/CDRX policies but the cell-B does not support the SPS/CDRX, the UE can apply an offset (bias) to rank any of the cells with a highest priority for camping, based on the following.

Specifically, the UE can rank the cell-A with a highest priority, if Rₙ=Q_{meas,n}−Qoffset+Offset_{PowerSave}; wherein Offset_{PowerSave} can be broadcasted by the network or implementation specific offset. Further, the UE can rank the cell-B with the highest priority if Rₙ=Q_{meas,n}−Qoffset. The variable Rₙ specifies the rank of the neighboring cells as defined in the 3GPP Specification 36.304. Qmeans is an RSRP measurement quantity used in cell reselections, as defined in the 3GPP Specification 36.304. The variable Qoffset_{s,n} specifies the offset between the two cells, as defined in 36.304, and Offset_{PowerSave} specifies the offset between the two cells, if probably target cell supports features, namely, SPS and/or CDRX, being introduced, which can be network specified or UE implementation.

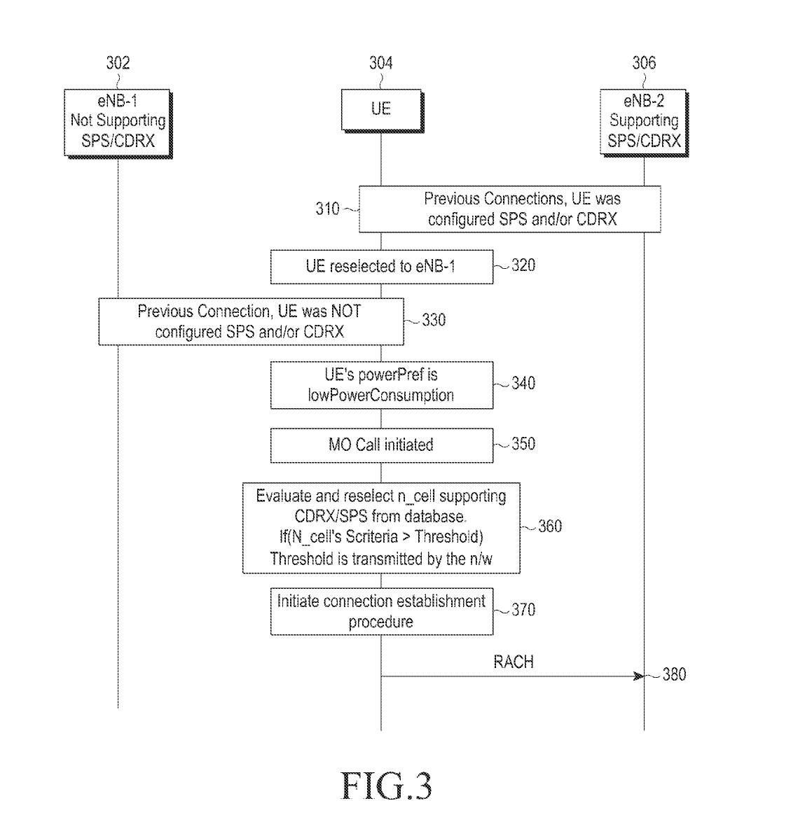

FIG. 3 illustrates a method of selecting cells that support SPS/CDRX, according to an embodiment of the present disclosure.

Referring to FIG. 3, a UE may maintain a list of cells that supports network policies that are being required by the UE. For example, the UE may maintain the list based on cell information received from a cell to which the UE was camped previously, cell information received from a cell to which the UE is currently connected, etc. Basically, the cell or eNB to which the UE is connected is not suggesting a new cell for the UE to connect to, but instead, the UE itself is evaluating and reselecting the cell for camping and getting connected to.

Specifically, a UE 304 was previously configured and connected to an eNB-2 306, which supports SPS/CDRX policies.

In step 310, the UE 304 reselects eNB-1 302, which does not support SPS/CDRX policies. Accordingly, the UE 304 was not configured with SPS/CDRX, when previously camped on the eNB-1 302.

The UE 304 checks the power status and identifies whether power consumption preference is set as low power consumption. In step 320, the UE 304 identifies that the power consumption preference of the UE 304 is set as low power consumption.

In step 330, upon initiation of a VOIP call, the UE 304 can access the list of cells that supports network policies that are being required by the UE 304. In step 340, the UE 304 evaluates the cells having a connectivity range within which the UE 304 is present, and reselects the cell supporting the SPS/CDRX, if selection a criteria (S-criteria) of a target cell is greater than a threshold. For example, the threshold value may be provided by a network.

Upon reselecting, in step 350, the UE 304 can initiate a connection establishment on an eNB-2 306, which has a good S-criteria and supports SPS/CDRX, by transmitting a random access channel in step 360.

The UE 302 treats the frequency of the eNB-2 306 cell as a high priority frequency.

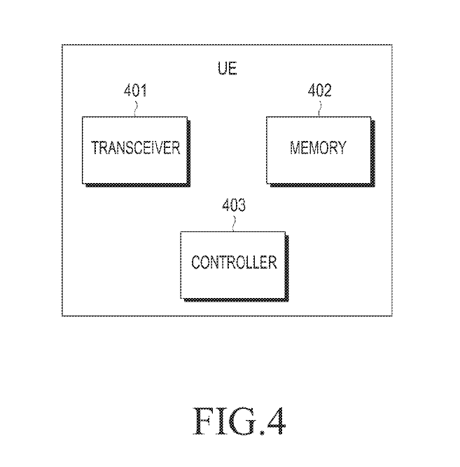

FIG. 4 is a block diagram illustrating a UE according to an embodiment of the present disclosure. Specifically, FIG. 4 illustrates a UE for performing the methods illustrated in FIGS. 1-3, as described above.

Referring to FIG. 4, the UE includes a transceiver 401 for communicating with eNBs, a memory 402 for storing information of the neighboring cells supporting the network feature and a plurality of parameters based on prior camping history and connection establishment of the UE, and a controller 403, e.g., a hardware processor, for controlling the overall operation of the UE. For example, the controller 403 determines if a selection criteria of a cell from among the at least one of the resident cell and the neighboring cell, which supports the network feature, is greater than a threshold, reselects the cell having the selection criteria that is greater than the threshold, and initiates a connection establishment with the reselected cell, which supports the network feature.

According to an embodiment herein, for VOLTE type applications on an LTE handset, a traffic pattern benefits from the use of SPS/CDRX, for increased power saving of the handset UE. Specifically, the SPS brings down the power consumption per TTI by almost 50%, when compared to dynamic scheduling, and another 10-15%, if connected DRX is used in the deployment. SPS and CDRX are eNB scheduler implementation, and also depend on UE support (capability information).

The methods described according to the embodiments herein assist a UE in early detection of SPS/CDRX capabilities in the eNB scheduler through explicit SIB transmission, or by an internal database in UE.

The various devices, modules, and the like described herein may be enabled and operated using hardware circuitry, for example, complementary metal oxide semiconductor based logic circuitry, firmware, software and/or any combination of hardware, firmware, and/or software embodied in a machine readable medium.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A method of a user equipment (UE) for reducing power consumption in the UE, the method comprising:
establishing, by the UE, a connection with a network;
receiving, by the UE, from the network, system information of at least one of a resident cell and a neighboring cell indicating if a network feature is supported by the at least one of the resident cell and the neighboring cell;
determining, by the UE, if a selection criteria of a cell from among the at least one of the resident cell and the neighboring cell, which supports the network feature, is greater than a threshold;
reselecting the cell having the selection criteria that is greater than the threshold; and
initiating a connection establishment with the reselected cell, which supports the network feature.

2. The method of claim 1, wherein the network feature comprises at least one of:
Semi-Persistent Scheduling (SPS); and
Connected-mode Discontinuous Reception (CDRX).

3. The method of claim 1, further comprising initiating a call, by the UE, before determining if the selection criteria of the cell from among the at least one of the resident cell and the neighboring cell, which supports the network feature, is greater than the threshold.

4. The method of claim 1, wherein the threshold is configured by the network or the UE.

5. The method of claim 1, further comprising:
maintaining, by the UE, information of neighboring cells supporting the network feature and a plurality of parameters based on prior camping history and connection establishment.

6. The method of claim 5, wherein determining if the selection criteria of the cell from among the at least one of the resident cell and the neighboring cell, which supports the network feature, is greater than the threshold, comprises evaluating, by the UE, the plurality of parameters to determine if the selection criteria of the cell supporting the network feature is greater than the threshold.

7. The method of claim 5, wherein the plurality of parameters comprises one of:
a high priority frequency associated with the cell; and
a equal priority frequency associated with the cell.

8. The method of claim 1, wherein the UE applies an offset to the selection criteria of the cell supporting the network features, when UE reselects a cell of a high priority frequency or an equal priority frequency.

9. The method of claim 8, wherein the offset is network configured or UE implemented.

10. A method of a user equipment (UE) for reducing power consumption in the UE, the method comprising:
storing, by the UE, information of neighboring cells supporting a network feature and a plurality of parameters based on prior camping history and connection establishment of the UE;
initiating a call through a network;
evaluating, by the UE, the plurality of parameters to determine if a selection criteria of a cell supporting the network feature is greater than a threshold;
reselecting the cell having the selection criteria that is greater than the threshold; and
initiating a connection establishment with the reselected cell, which supports the network feature.

11. The method of claim 10, wherein the network feature comprises at least one of:
Semi-Persistent Scheduling (SPS); and
Connected-mode Discontinuous Reception (CDRX).

12. The method of claim 10, wherein the threshold is configured by the network or the UE.

13. The method of claim 10, wherein the plurality of parameters comprises one of:
a high priority frequency associated with the cell; and
a equal priority frequency associated with the cell.

14. The method of claim 10, wherein the UE applies an offset to the selection criteria of the cell supporting the network features, when UE reselects a cell of a high priority frequency or an equal priority frequency.

15. The method of claim 14, wherein the offset is network configured or UE implemented.

16. An apparatus for reducing power consumption in a user equipment (UE), the apparatus comprising:
a transceiver configured to establish a connection with a network, to receive, from the network, system information of at least one of a resident cell and a neighboring cell indicating if a network feature is supported by the at least one of the resident cell and the neighboring cell; and
a controller configured to determine if a selection criteria of a cell from among the at least one of the resident cell and the neighboring cell, which supports the network feature, is greater than a threshold, to reselect the cell having the selection criteria that is greater than the threshold, and to initiate a connection establishment with the reselected cell, which supports the network feature.

17. The apparatus of claim 16, wherein the network feature comprises at least one of:
Semi-Persistent Scheduling (SPS); and
Connected-mode Discontinuous Reception (CDRX).

18. The apparatus of claim 16, wherein the controller is further configured to initiate a call, before determining if the selection criteria of the cell from among the at least one of the resident cell and the neighboring cell, which supports the network feature, is greater than the threshold.

19. The apparatus of claim 16, wherein the threshold is configured by the network or the UE.

20. The apparatus of claim 16, further comprising a memory configured to store information of neighboring cells supporting the network feature and a plurality of parameters based on prior camping history and connection establishment.
